(19) United States
(12) Patent Application Publication
(10) Pub. No.: US 2025/0330885 A1
(43) Pub. Date: Oct. 23, 2025

(54) TECHNIQUES FOR VOICE CALL STALL DETECTION AND MITIGATION

(71) Applicant: QUALCOMM Incorporated, San Diego, CA (US)

(72) Inventors: Yong XIE, San Diego, CA (US); Carlos Marcelo Dias PAZOS, Carlsbad, CA (US); Jiaheng LIU, Shanghai (CN); Jinxing WANG, Beijing (CN); Sanjeev MITTAL, San Diego, CA (US); Tom CHIN, San Diego, CA (US)

(21) Appl. No.: 18/857,780

(22) PCT Filed: Jun. 27, 2022
(86) PCT No.: PCT/CN2022/101397

§ 371 Date: Oct. 17, 2024

(51) Int. Cl. H04W 36/08; H04L 65/65; H04W 36/00; H04W 76/10

(52) U.S. Cl. CPC H04W 36/08; H04L 65/65; H04W 36/0058; H04W 76/10

(57) ABSTRACT

Methods, systems, and devices for wireless communications are described for identification of a voice call stall of a packet-switched voice call. A user equipment (UE) may establish a packet-based voice call with a peer device via a wireless communications system. The packet-based voice call may be evaluated by the UE to determine a presence of a voice call stall and, in the event that a voice call stall is detected, a handover of the UE to a different serving cell or a different radio access technology may be triggered. The voice call stall may be identified based on a threshold value of a quantity of voice call packets expected to be received during an evaluation period. In the event that a quantity of voice call packets received during the evaluation period is below the threshold value, a handover of the UE may be initiated.

### CROSS REFERENCE

The present Application is a 371 national stage filing of International PCT Application No. PCT/CN2022/101397 by XIE et al. entitled “TECHNIQUES FOR VOICE CALL STALL DETECTION AND MITIGATION,” filed Jun. 27, 2022, which is assigned to the assignee hereof, and which is expressly incorporated by reference in its entirety herein.

### FIELD OF TECHNOLOGY

The following relates to wireless communications, including techniques for voice call stall detection and mitigation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some cases, voice calls for a wireless communications system may be carried using packet-based techniques such as voice over Internet protocol (VoIP) or voice over IP multimedia subsystem (VoIMS). Such packet-based techniques provide that peer devices (e.g., two UEs that are in a voice call, or a UE and a different packet-based voice call device) exchange voice call packets that include voice data of a respective user. In some cases, voice calls may stall, which may result in users of the peer devices having a gap in communications or a call failure and termination. Techniques for reducing communications gaps or call failures may help to enhance user experience by providing more reliable and higher quality packet-based voice calls.

### SUMMARY

The described techniques relate to improved methods, systems, devices, and apparatuses that support techniques for voice call stall detection and mitigation. For example, the described techniques provide for a peer device (e.g., a user equipment (UE)) establishing a packet-based voice call with another peer device (e.g., a different UE or other packet-based voice call device) via a wireless communications system. The packet-based voice call may be evaluated on one or multiple occasions to determine a presence of a voice call stall. In the event that a voice call stall is detected, one or more mitigation actions may be taken, such as triggering a handover at a physical layer of a UE to a different serving cell, that may help avoid a termination of the call and help enhance user experience. In some cases, a voice call stall may be identified based on a threshold value for a voice stall, where the threshold value is based on a quantity of voice call packets expected to be received during an active call state of the packet-based voice call during an evaluation period. In the event that a quantity of voice call packets received during the evaluation period is below the threshold value, a handover from a first serving cell to a different serving cell may be initiated.

A method for wireless communication at a UE is described. The method may include establishing a packet-based voice call with a peer device via a first wireless network entity of a wireless communications system, identifying a threshold value for a voice stall of the packet-based voice call, the threshold value based on a quantity of voice call packets expected to be received during an active call state of the packet-based voice call during an evaluation period, and initiating a handover of the UE from the first wireless network entity to a different wireless network entity responsive to the quantity of voice call packets received from the peer device during the evaluation period being below the threshold value for the voice stall of the packet-based voice call.

An apparatus for wireless communication at a UE is described. The apparatus may include a processor, memory coupled with the processor, and instructions stored in the memory. The instructions may be executable by the processor to cause the apparatus to establish a packet-based voice call with a peer device via a first wireless network entity of a wireless communications system, identify a threshold value for a voice stall of the packet-based voice call, the threshold value based on a quantity of voice call packets expected to be received during an active call state of the packet-based voice call during an evaluation period, and initiate a handover of the UE from the first wireless network entity to a different wireless network entity responsive to the quantity of voice call packets received from the peer device during the evaluation period being below the threshold value for the voice stall of the packet-based voice call.

Another apparatus for wireless communication at a UE is described. The apparatus may include means for establishing a packet-based voice call with a peer device via a first wireless network entity of a wireless communications system, means for identifying a threshold value for a voice stall of the packet-based voice call, the threshold value based on a quantity of voice call packets expected to be received during an active call state of the packet-based voice call during an evaluation period, and means for initiating a handover of the UE from the first wireless network entity to a different wireless network entity responsive to the quantity of voice call packets received from the peer device during the evaluation period being below the threshold value for the voice stall of the packet-based voice call.

A non-transitory computer-readable medium storing code for wireless communication at a UE is described. The code may include instructions executable by a processor to establish a packet-based voice call with a peer device via a first wireless network entity of a wireless communications system, identify a threshold value for a voice stall of the packet-based voice call, the threshold value based on a quantity of voice call packets expected to be received during an active call state of the packet-based voice call during an evaluation period, and initiate a handover of the UE from the first wireless network entity to a different wireless network entity responsive to the quantity of voice call packets received from the peer device during the evaluation period being below the threshold value for the voice stall of the packet-based voice call.

Some examples of the method, apparatuses, and non-transitory computer-readable medium described herein may further include operations, features, means, or instructions for receiving, from the peer device, an indication of a quantity of packets transmitted from the peer device for the packet-based voice call, and where the initiating the handover of the UE may be based on a ratio of the quantity of voice call packets received from the peer device and the quantity of packets transmitted from the peer device during the evaluation period. In some examples of the method, apparatuses, and non-transitory computer-readable medium described herein, the indication of the quantity of packets transmitted from the peer device may be received in a real-time transport control protocol (RTCP) sender report from the peer device.

Some examples of the method, apparatuses, and non-transitory computer-readable medium described herein may further include operations, features, means, or instructions for determining that an elapsed time since receipt of a report associated with the packet-based voice call exceeds a time threshold, and where the initiating the handover of the UE may be based on the quantity of voice call packets received from the peer device and an estimated quantity of voice call packets associated with an assumed mixed voice pattern for the evaluation period. In some examples of the method, apparatuses, and non-transitory computer-readable medium described herein, the report associated with the packet-based voice call may be a RTCP report.

In some examples of the method, apparatuses, and non-transitory computer-readable medium described herein, the threshold value may be based on a silence indicator (SID) interval of the packet-based voice call, where a higher SID interval may have a lower threshold value, and a lower SID interval may have a higher threshold value. Some examples of the method, apparatuses, and non-transitory computer-readable medium described herein may further include operations, features, means, or instructions for estimating, for the evaluation period, a ratio of an expected quantity of packets transmitted from the peer device during the evaluation period and a maximum quantity of packets that can be transmitted during the evaluation period, and where the threshold value is determined based on the estimated ratio. In some examples of the method, apparatuses, and non-transitory computer-readable medium described herein, a value of the ratio that is less than a silence threshold indicates that the peer device is silent, and the UE is to refrain from triggering the handover for the evaluation period. In some examples of the method, apparatuses, and non-transitory computer-readable medium described herein, the quantity of voice call packets received from the peer device during the evaluation period is based on voice call packets that have real-time transport protocol (RTP) timestamps that are within the evaluation period.

In some examples of the method, apparatuses, and non-transitory computer-readable medium described herein, the identifying the threshold value for the voice stall, and the initiating the handover of the UE may be performed as part of a voice call stall evaluation, and where the method may include operations, features, means, or instructions for receiving at least one RTCP sender report that indicates a quantity of RTP voice packets transmitted during the evaluation period and initiating the voice call stall evaluation responsive to the at least one RTCP sender report, where the threshold value is based on the quantity of RTP voice packets indicated in the sender report and a quantity of SID frames within the evaluation period.

In some examples of the method, apparatuses, and non-transitory computer-readable medium described herein, the identifying the threshold value for the voice stall, and the initiating the handover of the UE may be performed as part of a voice call stall evaluation, and where the method may include operations, features, means, or instructions for determining that a time period since a prior evaluation period has elapsed, and that a RTCP sender report has not been received within the time period, and initiating the voice call stall evaluation responsive to the determining, where the threshold value is based on an assumed mixed voice pattern for the packet-based voice call. In some examples of the method, apparatuses, and non-transitory computer-readable medium described herein, the threshold value for identifying the voice stall of the packet-based voice call may be an adaptive threshold that is based on an amount of voice activity present during the evaluation period.

Some examples of the method, apparatuses, and non-transitory computer-readable medium described herein may further include operations, features, means, or instructions for receiving a handover message that indicates handover of the UE from the first wireless network entity to a second wireless network entity, where the second wireless network entity uses a same radio access technology (RAT) as the first wireless network entity or a different RAT than the first wireless network entity. In some examples of the method, apparatuses, and non-transitory computer-readable medium described herein, the initiating the handover of the UE may include operations, features, means, or instructions for modifying a criteria for transmission of a measurement report to the first wireless network entity that triggers handover of the UE, where the measurement report may be an inter-RAT measurement report or an intra-RAT measurement report based on measured channel conditions associated with wireless network entities of two or more RATs.

### BRIEF DESCRIPTION OF THE DRAWINGS

FIG. 1 illustrates an example of a wireless communications system that supports techniques for voice call stall detection and mitigation in accordance with one or more aspects of the present disclosure.

FIG. 2 illustrates an example of a wireless communications system that supports techniques for voice call stall detection and mitigation in accordance with one or more aspects of the present disclosure.

FIG. 3 illustrates an example of a flow chart for voice call stall detection and mitigation in accordance with one or more aspects of the present disclosure.

FIGS. 4A through 4D illustrate examples of timing diagrams that support techniques for voice call stall detection and mitigation in accordance with one or more aspects of the present disclosure.

FIG. 5 illustrates an example of a process flow that supports techniques for voice call stall detection and mitigation in accordance with one or more aspects of the present disclosure.

FIGS. 6 and 7 show block diagrams of devices that support techniques for voice call stall detection and mitigation in accordance with one or more aspects of the present disclosure.

FIG. 8 shows a block diagram of a communications manager that supports techniques for voice call stall detection and mitigation in accordance with one or more aspects of the present disclosure.

FIG. 9 shows a diagram of a system including a device that supports techniques for voice call stall detection and mitigation in accordance with one or more aspects of the present disclosure.

FIGS. 10 through 15 show flowcharts illustrating methods that support techniques for voice call stall detection and mitigation in accordance with one or more aspects of the present disclosure.

### DETAILED DESCRIPTION

In some cases, voice calls for a wireless communications system may be carried using packet-based techniques such as voice over IP multimedia subsystem (VoIMS) techniques (e.g., voice over LTE (VoLTE), voice over NR (VoNR)). Such packet-based techniques provide that a user equipment (UE), which may be an example of a peer device, may exchange voice call packets with another peer device, where the voice call packets include voice data of a respective user. In some cases, voice calls may stall, which may result in users of the peer devices having a gap in communications or a call failure and termination. Techniques for reducing communications gaps or call failures may help to enhance user experience by providing more reliable and higher quality packet-based voice calls.

A voice stall may occur during an active VoIMS (e.g., VoLTE or VoNR) call for any of multiple different reasons (e.g., poor channel quality of a wireless connection, network congestion, etc.), and irrespective of the reason a user may experience gaps in communication that may result in a poor user experience. Various techniques as discussed herein provide that a voice stall may be detected at a UE, and in some cases, the UE may detect a voice stall for downlink transmissions to the UE before user perception becomes bad, and the UE may proactively move to another serving cell or move to a different radio access technology (RAT). Such techniques may help to improve user experience and enhance network efficiency.

In some cases, a real-time transport protocol (RTP) application may run at an application layer of the UE, and may manage packet-based voice calls (e.g. VoIMS calls) according to a read-time transport control protocol (RTCP). In some traditional UEs, the RTP application at a UE may terminate a call after a certain period of time (e.g., 20 seconds) during which voice packets are not received at the RTP application. In such cases, the RTP application simply terminates the voice call, and does not provide any information or take any action to mitigate call interruptions in advance of terminating the call. Such techniques may lead to a poor user experience, because the call is not terminated for a relatively long time duration (e.g., 20 s), and the user either has to wait for that relatively long time duration for the termination or has to terminate the call themselves prior to the time duration expiration. Further, in some cases a voice call may have intermittent stalls that have a shorter duration than the time period that results in call termination at the RTP application (e.g., a voice call may stall for multiple four or five second durations), but result in a poor user experience.

In accordance with techniques as discussed herein, a UE may establish a packet-based voice call with a peer device (e.g., a different UE or other packet-based voice call device) via a wireless communications system. The packet-based voice call may be evaluated by the UE on one or multiple occasions to determine a presence of a voice call stall. In the event that a voice call stall is detected, one or more mitigation actions may be taken, such as triggering a handover at a physical layer of the UE to a different serving cell, that may help avoid a termination of the call and help enhance user experience. In some cases, a voice call stall may be identified based on a threshold value for a voice stall, where the threshold value is based on a quantity of voice call packets expected to be received during an active call state of the packet-based voice call during an evaluation period. In the event that a quantity of voice call packets received during the evaluation period is below the threshold value, a handover from a first serving cell to a different serving cell may be initiated.

In some cases, a RTP application at the UE may monitor voice packets received from the peer device, and compare a number of received packets against the threshold value to determine whether the voice call has stalled or not. In some cases, the threshold value may be an adaptive value that is based on a number of voice packets indicated in a RTCP sender report, a silence indicator (SID) interval (e.g., a SID frame is transmitted at the SID interval to indicate that there is no voice to transmit from the peer device), a default mixed voice pattern (e.g., 40% talk, 40% listen, 20% silent), or combinations thereof. The threshold value may be determined for each evaluation period based on estimated voice activity, and if a number of received voice packets during the evaluation period is less than the threshold (e.g., if less than 20% of the expected voice packets are received), the UE may enter a voice stall mode. In the event that it is determined that the voice call has stalled, the RTP application at the application layer may trigger lower layers (e.g., RRC/MAC layer) at the UE to initiate a handover of the UE to a different serving cell or a different RAT. In some cases, the lower layers may force a measurement report transmission that initiates the handover, such as through a one-time adjustment of a reference signal received power (RSRP) delta of neighboring cells for triggering the measurement report transmission to initiate handover.

Aspects of the disclosure are initially described in the context of wireless communications systems. Aspects of the disclosure are further illustrated by and described with reference to timing diagrams, process flows, apparatus diagrams, system diagrams, and flowcharts that relate to techniques for voice call stall detection and mitigation.

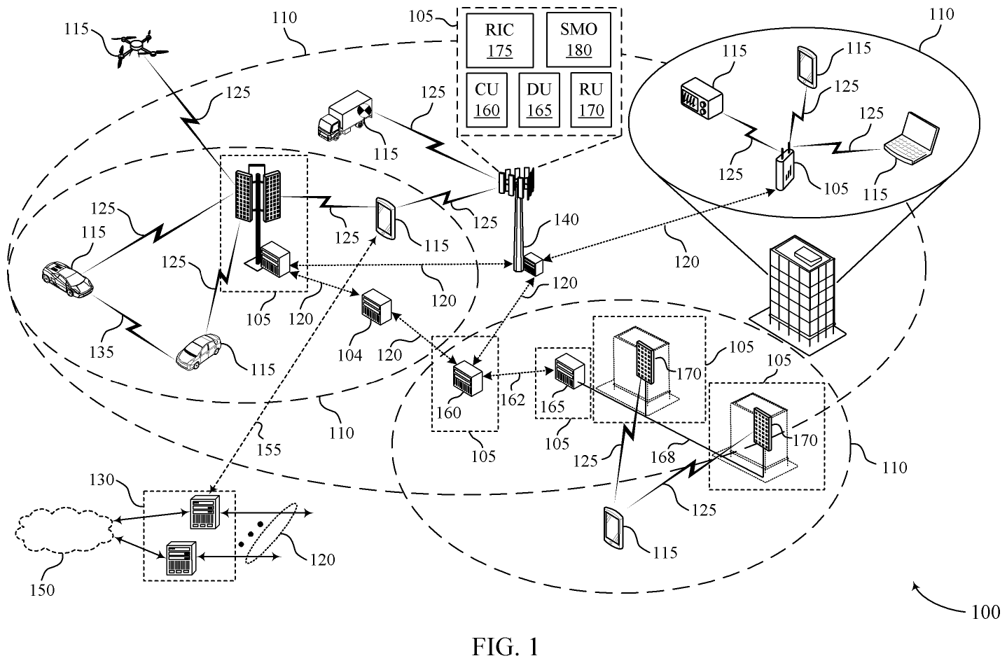

FIG. 1 illustrates an example of a wireless communications system 100 that supports techniques for voice call stall detection and mitigation in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for voice call stall detection and mitigation as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some cases, a UE 115 may establish a packet-based voice call with a peer device (e.g., a different UE 115 or other packet-based voice call device such as an Internet-connected VoIP phone) via a wireless communications system. The packet-based voice call may be evaluated by the UE 115 on one or multiple occasions to determine a presence of a voice call stall. In the event that a voice call stall is detected, one or more mitigation actions may be taken, such as triggering a handover at a physical layer of the UE 115 to a different serving cell, that may help avoid a termination of the call and help enhance user experience. In some cases, a voice call stall may be identified based on a threshold value for a voice stall, where the threshold value is based on a quantity of voice call packets expected to be received during an active call state of the packet-based voice call during an evaluation period. In the event that a quantity of voice call packets received during the evaluation period is below the threshold value, a handover from a first serving cell to a different serving cell may be initiated.

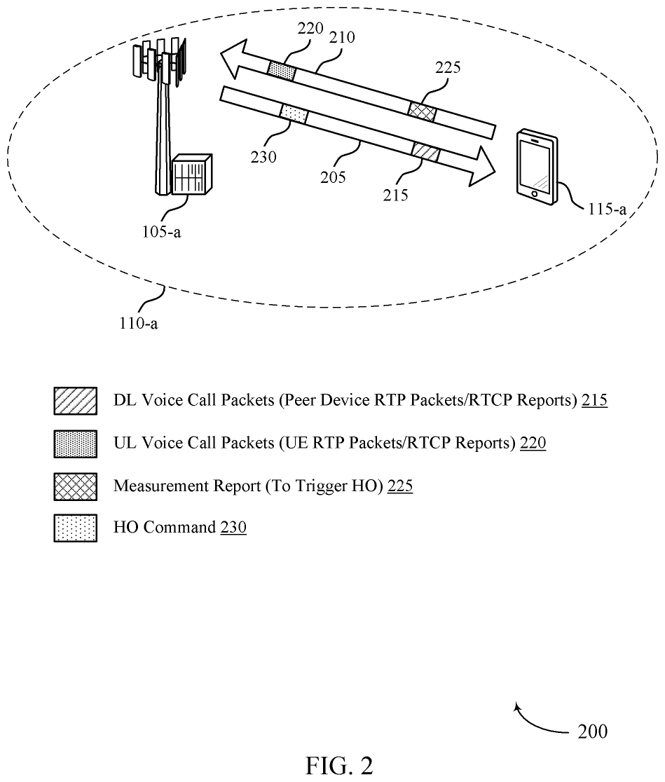

FIG. 2 illustrates an example of a wireless communications system 200 that supports techniques for voice call stall detection and mitigation in accordance with one or more aspects of the present disclosure. The wireless communications system 200 may include a network entity 105-a and a UE 115-a, which may represent examples of a network entity 105 and UE 115 as described with reference to FIG. 1. In this example, the UE 115-a may communicate with the network entity 105-a within coverage area 110-a via a downlink carrier 205 and an uplink carrier 210 (e.g., which may be different carriers operating using FDD, or a same carrier operating using TDD).

In some cases, the UE 115-a may establish a packet-based voice call with a peer device (e.g., another UE, a VoIMS-enabled device, etc.) via the network entity 105-a and an associated network (e.g., core network 130 of FIG. 1). In some cases, the packet-based voice call may be managed at an RTP application at an application layer of the UE 115-a, and the UE 115-a may receive downlink voice call packets 215 (e.g., RTP packets, RTCP reports, or both, from the peer device) via downlink carrier 205. As part of the packet-based voice call, the UE 115-a may transmit uplink voice call packets 220 (e.g., RTP packets, RTCP reports, or both, from the UE 115-a) via uplink carrier 210. In accordance with various aspects as discussed herein, the UE 115-a may evaluate the downlink voice call packets 215 and determine a presence or absence of a voice call stall. In the event that a voice call stall is detected, the UE 115-a may transmit a measurement report 225 to the network entity 105-a that triggers a handover of the UE 115-a. In some cases, the network entity 105-a may transmit a handover command 230 to the UE 115-a to trigger a handover from a first serving cell to a different serving cell, or to a different RAT (e.g., served by a different network entity in a wireless communications network that is different than wireless communications system 200).

In some cases, a threshold value for a voice stall of the packet-based voice call may be identified, based at least in part on a quantity of voice call packets expected to be received during an active call state of the packet-based voice call during an evaluation period. The UE 115-a may trigger the handover responsive to the quantity of voice call packets received from the peer device during the evaluation period being below the threshold value. For example, the UE 115-a may receive an indication of a quantity of packets transmitted from the peer device for the packet-based voice call (e.g., in a RTCP sender report (SR)), and may initiate the handover is based at least in part on a ratio of the quantity of voice call packets received from the peer device and the quantity of packets transmitted from the peer device during the evaluation period. Various examples of setting the threshold value and determining a presence of a voice call stall are discussed herein.

For example, the threshold value may be adaptive based on a number of voice packets indicated in a RTCP SR, a SID interval (e.g., a SID frame is transmitted at the SID interval to indicate that there is no voice to transmit from the peer device), a default mixed voice pattern (e.g., 40% talk, 40% listen, 20% silent), or any combinations thereof. In some cases, the threshold value may be determined for each evaluation period based on estimated voice activity, and if a number of received voice packets during the evaluation period is less than the threshold (e.g., if less than 20% of the expected voice packets are received), the UE 115-a may enter a voice stall mode. In the event that it is determined that the voice call has stalled, the RTP application at the application layer may trigger the UE 115-a lower layers (e.g., RRC/MAC layers) to initiate a handover of the UE 115-a to a different serving cell. In some cases, the lower layers may force a measurement report 225 transmission that initiates a handover, such as through a one-time adjustment of a RSRP delta for triggering the measurement report 225 transmission to initiate handover.

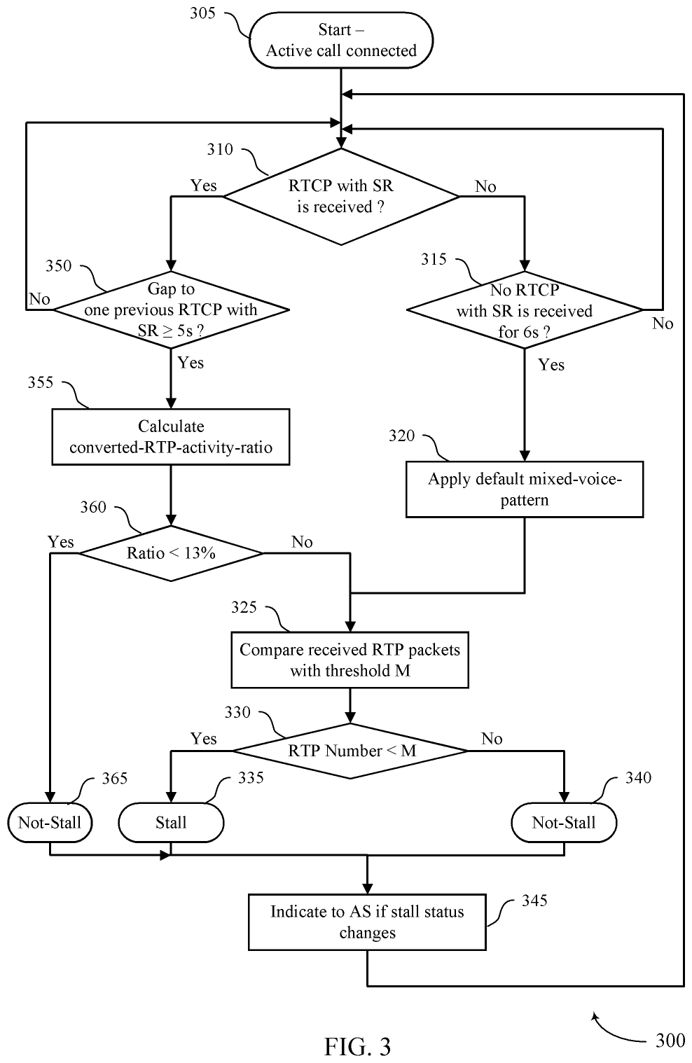

FIG. 3 illustrates an example of a flow chart 300 that supports techniques for voice call stall detection and mitigation in accordance with one or more aspects of the present disclosure. The flow chart 300 may be implemented in various aspects of the present disclosure described with reference to FIGS. 1 and 2. For example, the flow chart 300 may illustrate operations at a UE (e.g., a UE 115), which may be an example of corresponding devices as described with reference to FIGS. 1 and 2. Alternative examples of the following may be implemented, where some steps are performed in a different order than described or are not performed at all. In some cases, an operation may include additional features not mentioned below, or further operations may be added.

At 305, the UE may start a voice call stall evaluation based on a presence of an active voice call that is in a connected state. In some cases, the voice call stall evaluation may be performed at an upper layer (e.g., an application layer) of the UE, such as an RTP application operating at the application layer of the UE. In some cases, the voice call stall evaluation is performed for active voice calls, and is not performed for voice calls that are in a hold state.

At 310, the UE may determine whether RTCP information with a sender report (SR) is received at the UE. In some cases, the RTP application at the UE may receive a RTCP SR, and determine various items of information from the SR, such as an identification of the sender, one or more timestamps associated with RTP communications, a sender's packet count (e.g., a 32-bit field in the SR that indicates a total number of RTP data packets transmitted by the sender since starting transmission up until the time the SR was generated), a sender's octet count, or any combinations thereof.

At 315, if it is determined that RTCP with SR is not received, the UE may determine whether a RTCP with SR has not been received for a time threshold (e.g., 6 seconds) associated with a SR. If less than the time threshold has elapsed since a prior RTCP SR has been received, the UE continues with operations at block 310. At 320, if the time threshold since a RTCP SR receipt meets or exceeds the time threshold, the UE may apply a default mixed-voice pattern for RTP packets that are received during an evaluation period. In some cases, the mixed-voice pattern may be 40% talk, 40% listen, and 20% silent. In some cases, the mixed-voice pattern may be adaptive based on a pattern associated with the voice call (e.g., since a start of the voice call), or a pattern for a recent portion of the voice call (e.g., a pattern for a prior 10 second time period). In some cases, the adaptive mixed-voice pattern may be determined using machine learning (ML) or artificial intelligence (AI) techniques.

At 325, the UE may compare received RTP packets with a threshold value (e.g., threshold value M). In some cases, the threshold value may be an adaptive threshold value that is identified separately for each evaluation period, as discussed in various aspects herein. At 330, the UE determines whether the number of RTP packets for the voice call are below the threshold value. At 335, the UE may identify a voice call stall if the number of RTP packets received for the evaluation period is less than the threshold value. At 340, the UE may identify that the voice call is not in a voice call stall if the number of RTP packets received for the evaluation period is at or above the threshold value. At 345, the UE may indicate to an access stratum (AS) layer if a call status has changed (e.g., if the call status is voice call stall, which may initiate transmission of a measurement report to trigger a handover of the UE). The operations may then be continued at 310 for a subsequent evaluation period.

At 350, in the event that the UE receives a RTCP with SR at 310, the UE determines whether a gap to a previously received RTCP with SR is less than a time period (e.g., 5 seconds). If the gap to a previously received RTCP is less than the time period, the UE may continue with operations at 310. At 355, if the gap to a previously received RTCP meets or exceeds the time period, the UE may calculate a converted RTP activity ratio. In some cases, the converted RTP activity ratio may be calculated based on a total expected RTP packet number in one evaluation window (e.g., based on a packet count in the RTCP SR). In some cases, the converted RTP activity ratio may be calculated as an expected number of RTP packets (e.g., based on a difference in packet counts between RTCP SRs at a beginning and end of the evaluation period) divided by the evaluation window size that is adjusted based on reported voice packets in the RTCP SR and a SID interval. In one example, such a ratio may be calculated as:

converted-RTP-activity-ratio=expected-RTP-number-in-evaluation-window/(evaluation-window-size*50)*(X/160 ms)

where the evaluation-window size is 5˜6 s based on RTCP reception, the expected-RTP-number-in-evaluation-window is a difference between two “sender's packet count” in the RTCP SRs at the beginning and end of the evaluation window, 50 is the total RTP number in one second if all RTP packets are voice packets, X is the SID interval and X/160 provides a conversion to a 160 ms SID interval.

For example, if the evaluation-window-size=5 s, when the SID interval=160 ms and peer UE is not talking (e.g., the evaluation window is all SID frames, corresponding to 31.25 SID frames), the converted-RTP-activity-ratio=31/250*(160 ms/160 ms)=12.4%. In another example, the evaluation window side is 5 seconds and the SID interval is one second, and the peer UE is not talking (e.g., the evaluation window is all SID frames, corresponding to 5 SID frames), the converted-RTP-activity-ratio=5/250*(1000 ms/160 ms)=12.5%. In some cases, the SID interval (X), may be determined based on a coding rate associated with the voice call (e.g., adaptive multi-rate (AMR), AMR-wide-band (AMR-WB), enhanced voice services (EVS) without discontinuous reception (DRX) may have X=160 ms; and EVS with DTX may have X set to one of the latest received SID interval, the average SID interval in the evaluation window, the maximum SID interval in the evaluation window, or the minimum SID interval in evaluation window). In some cases, as the SID interval (X) goes higher, less RTP packets are expected to be received, which results in a lower stall threshold and a stricter trigger indicate a stall; and as the SID interval (X) goes lower, more RTP packets are expected to be received, which results in a higher stall threshold and a less strict trigger to indicate a stall.

At 360, the UE may determine whether the calculated converted RTP activity ratio is less than 13%. In some cases, a RTP-activity-ratio at or above 13% to may indicate that the evaluation period is not an all-SID period. At 365, if it is determined that the converted RTP activity ratio is less than 13%, the UE may identify that the voice call is not in a voice call stall (e.g., a stall is not triggered if the peer user is not talking and the evaluation period includes all SID frames). If it is determined at 360 that the converted RTP activity ratio is at or above 13%, the operations at 325 may be performed.

Thus, using such techniques, a voice call stall may be evaluated based on an adaptive threshold that is calculated for each evaluation period, where the UE determines a voice call stall when a number of received RTP packets in the evaluation window is less than the threshold value (M). If the evaluation is triggered by RTCP with SR (e.g., when a gap to a previous RTCP with SR is 5 seconds or greater), the UE calculates the converted-RTP-activity-ratio, and calculates an number of expected RTP packets in the evaluation window based on the Sender's packet count in the RTCP SRs. The UE may calculate the threshold value (M) based on the number of expected RTP packets and a target RTP loss ratio (e.g., an 80% loss ratio, such that if the number of received RTP packets is less than 20% of the number of expected RTP packets, a stall is identified). In some cases, the quantity of voice packets received in the evaluation window are determined by counting received RTP packets with an RTP-timestamp falling into the RTP-timestamps of RTCP SR packets at the evaluation window boundaries. Further, in cases where the converted-RTP-activity-ratio is less than 13%, the UE declares not-Stall because of peer side is not talking. However, if SR reports are not received, the UE may perform a voice call stall evaluation based on an expiration of a timer, where a mixed voice pattern is assumed for the evaluation window (e.g., 40% listen, 20% silent, 40% talk, or a 40/20/40 mixed-pattern), and the threshold value determined based on the assumed mixed voice pattern.

For example, with such a mixed voice pattern an expected number of voice packets (in a 6 s evaluation window with a 20 ms frame rate) would be: 2400 ms/20 ms+3600 ms/X ms=120+3600/X. Table 1 illustrates an example of threshold values (M) for different scenarios with a 20 ms frame, a five second evaluation window when a RTCP SR is available, and a six second evaluation window when a RTCP SR is not available:

TABLE 1
M values in presence or absence of
RTCP SR, and RTP loss ratio target

| | | SenderReport is not | |
|---|---|---|---|
| | | available (using | RTP loss |
| | SenderReport | default mixed-pattern | ratio target |
| | is available | 40/20/40) | (%) |
| Threshold M | M = (1 − y) * | M/(120 + 3600/x) = | y |
| (=number of | expected-RTP- | 1 − y | |
| received RTP | number-in- | → | |
| packets in one | evaluation- | M = (1 − y) * (120 + | |
| evaluation | window | 3600/x) | |
| window) | | | |

Table 2 illustrates an example of threshold values (M) for different scenarios with a five second evaluation window when a RTCP SR is available, with different SID intervals:

TABLE 2
M values in different scenarios based
on RTCP SR, and RTP loss ratio target

| | | | | | RTP |
|---|---|---|---|---|---|
| | | | | | loss |
| | All | Talk 1 s | Talk 3 s | | ratio |
| | SID | in 5 s | in 5 s | All voice | target |
| SID | Not- | M = (1 − | M = (1 − | M = (1 − | y = 80% |
| interval = | Stall | 0.8)*(50 + | 0.8)*(150 + | 0.8)*250 = | |
| 160 ms | | 25) = 15 | 12) = 32 | 50 | |
| SID | Not- | M = (1 − | M = (1 − | Same as | |
| interval = | Stall | 0.8)*(50 + | 0.8)*(150 + | above | |
| 1 s | | 4) = 11 | 2) = 30 | | |

In some cases, after detection of voice call stall, the UE may trigger a handover or mobility to another RAT (e.g., a second RAT) or to another cell of the RAT that is used to initiate the voice call (e.g., a first RAT). In some cases, the UE may trigger a handover or mobility to the second RAT when no cell in the first RAT is available for handover. In some cases, the inter-RAT or intra-RAT handover may be triggered by transmitting a measurement report that, when received at a network entity, triggers a handover of the UE. In some cases, the UE may transmit the measurement report by overriding a measurement report criteria that triggers transmission of the measurement report. For example, the UE may be configured to transmit a measurement report when a reference signal received power (RSRP) of a target cell exceed a RSRP of a serving cell by 3 dB, and in the event that the voice call stall is indicated, the value may be adjusted such that the measurement report is transmitted if the RSRP of the target cell exceeds the RSRP of the serving cell by at least −3 dB. Thus, the measurement report that triggers the handover may be transmitted more quickly in the event that a voice call stall is detected. The network entity that receives the measurement report from the UE may then trigger a handover procedure.

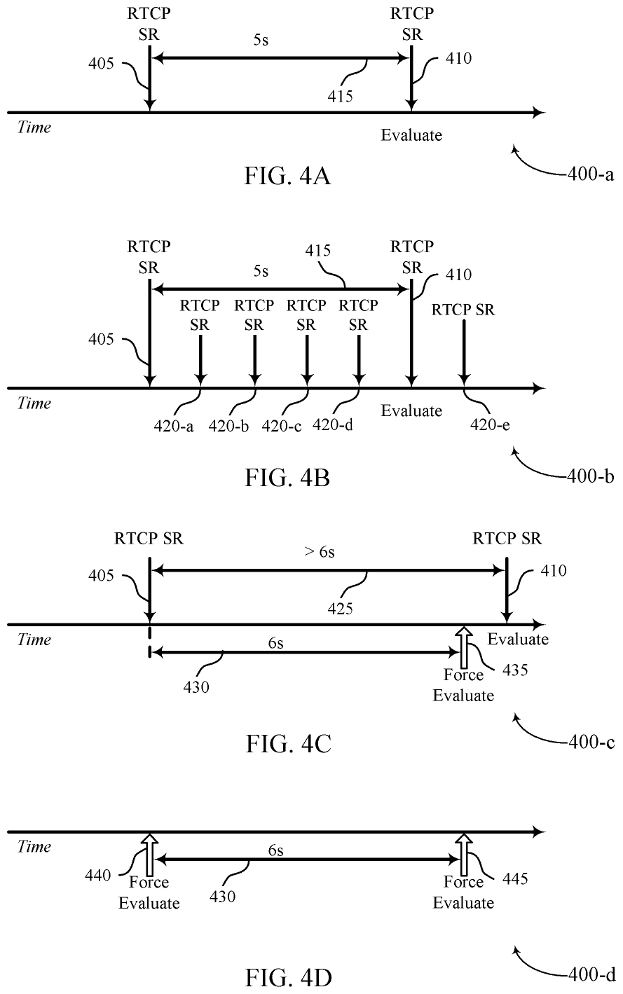

FIGS. 4A through 4D illustrate examples of timing diagrams 400 that support techniques for voice call stall detection and mitigation in accordance with one or more aspects of the present disclosure. The timing diagrams 400 may be implemented in various aspects of the present disclosure described with reference to FIGS. 1 and 2.

In a first example timing diagram 400-a of FIG. 4A, a first RTCP SR 405 and a second RTCP SR 410 may be received at a UE with a voice call stall evaluation window 415 of five seconds for evaluations based on RCTP SRs. In this example, the consecutive RTCP SRs 405 and 410 may be transmitted at five second intervals, and the UE may evaluate for a voice call stall based on the received SRs.

In a second example timing diagram 400-b of FIG. 4B, a first RTCP SR 405 and a second RTCP SR 410 may be received at a UE with a voice call stall evaluation window 415 of five seconds based on RCTP SRs. In this example, SRs are transmitted at one second intervals, and multiple additional RTCP SRs 420-a through 420-e may be transmitted. In such cases, the UE may evaluate for a voice call stall based on the first RTCP SR 405 and a SR that is received most recently prior to the end of the evaluation window 415, which in this example is the second RTCP SR 410.

In a third example timing diagram 400-c of FIG. 4C, a first RTCP SR 405 and a second RTCP SR 410 may be received at a UE with a voice call stall evaluation window 430 of six seconds based on no RTCP SR reception within the evaluation window 430. In this example, the first RTCP SR 405 is received at the start of the voice call stall evaluation window 430, but a time period 425 of greater than 6 seconds elapses prior to the receipt of the second RTCP SR 410. In such cases, a forced evaluation 435 may be conducted at the end of the voice call stall evaluation window 430. Further, in such cases, the UE may again evaluate for a voice call stall based on receipt of the second RTCP SR 410.

In a fourth example timing diagram 400-d of FIG. 4D, no RTCP SRs may be received at the UE, and a first forced voice call stall evaluation 440 may be performed, with a voice call stall evaluation window 430 of six seconds based on no RTCP SR reception within the evaluation window 430. In this example, no RTCP SR is received within the six second voice call stall evaluation window 430, and the UE may perform a second forced voice call stall evaluation 445 based on the expiration of voice call stall evaluation window 430.

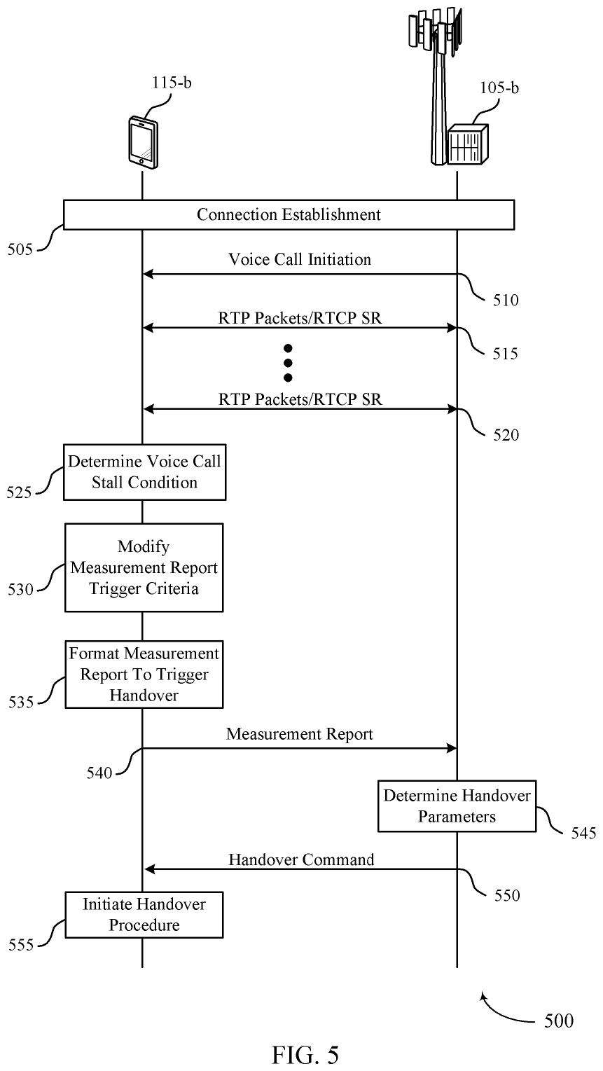

FIG. 5 illustrates an example of a process flow 500 that supports techniques for voice call stall detection and mitigation in accordance with one or more aspects of the present disclosure. The process flow 500 may include various aspects of the present disclosure described with reference to FIGS. 1 through 4D. For example, the process flow 500 may illustrate communications between a UE 115-b and a network entity 105-b, which may be examples of corresponding devices as described with reference to FIGS. 1 and 2. Alternative examples of the following may be implemented, where some steps are performed in a different order than described or are not performed at all. In some cases, a step may include additional features not mentioned below, or further steps may be added.

At 505, the network entity 105-b and UE 115-b may establish a connection for communications. In some cases, the connection establishment may be performed in accordance with connection establishment techniques for a wireless communication system (e.g., through a RRC connection establishment or reestablishment procedure).

At 510, the network entity 105-b may transmit information to the UE 115-b that indicates a voice call initiation. In some cases, the voice call initiation may be provided through an RTP application running at higher layers at the UE 115-b and network entity 105-b (e.g., at an RTP layer or application layer). At 515 through 520, the UE 115-b and network entity 105-b may exchange RTP packets, RTCP SRs, or any combinations thereof, as part of the packet-based voice call.

At 525, the UE may determine a voice call stall condition. The voice call stall condition may be determined in accordance with various techniques as discussed herein, such as based on an adaptive threshold value of RTP packets received in an evaluation period.

At 530, the UE 115-b may modify a measurement report trigger criteria based on the voice call stall condition. In some cases, the application layer that indicates the voice call stall condition may cause a lower layer at the UE 115-b (e.g., RRC layer or MAC layer) to modify the measurement report trigger criteria. At 535, the UE 115-b may format the measurement report to trigger a handover of the UE, and at 540 the UE 115-b may transmit the measurement report to the network entity 105-b.

At 545, the network entity 105-b may determine handover parameters for the UE 115-b, responsive to the measurement report. In some cases, the network entity 105-b may coordinate with another network entity (e.g., a target cell of a same RAT or a different RAT) to support handover of the UE 115-b to the other network entity. At 550, the network entity 105-b may transmit a handover command to the UE 115-b that indicates to handover to a different cell or RAT. At 555, the UE 115-b may initiate the handover procedure.

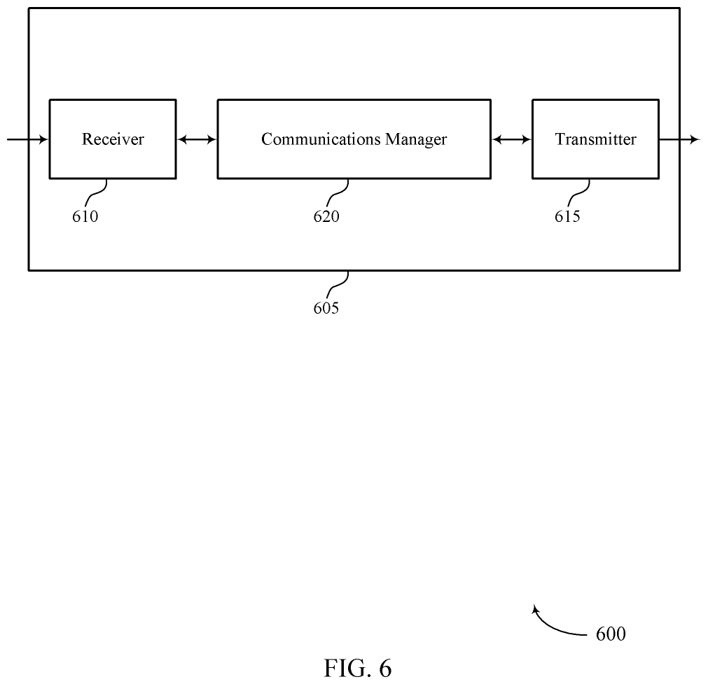

FIG. 6 shows a block diagram 600 of a device 605 that supports techniques for voice call stall detection and mitigation in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for voice call stall detection and mitigation). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for voice call stall detection and mitigation). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of techniques for voice call stall detection and mitigation as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. For example, the communications manager 620 may be configured as or otherwise support a means for establishing a packet-based voice call with a peer device via a first wireless network entity of a wireless communications system. The communications manager 620 may be configured as or otherwise support a means for identifying a threshold value for a voice stall of the packet-based voice call, the threshold value based on a quantity of voice call packets expected to be received during an active call state of the packet-based voice call during an evaluation period. The communications manager 620 may be configured as or otherwise support a means for initiating a handover of the UE from the first wireless network entity to a different wireless network entity responsive to the quantity of voice call packets received from the peer device during the evaluation period being below the threshold value for the voice stall of the packet-based voice call.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for voice call stall evaluation based on a threshold value for a received number of voice packets during an evaluation period, which may mitigate gaps in voice calls to provide an enhanced user experience, enhanced reliability for packet-based voice calls, and/or provide enhanced network efficiency through fewer call failures or call terminations.

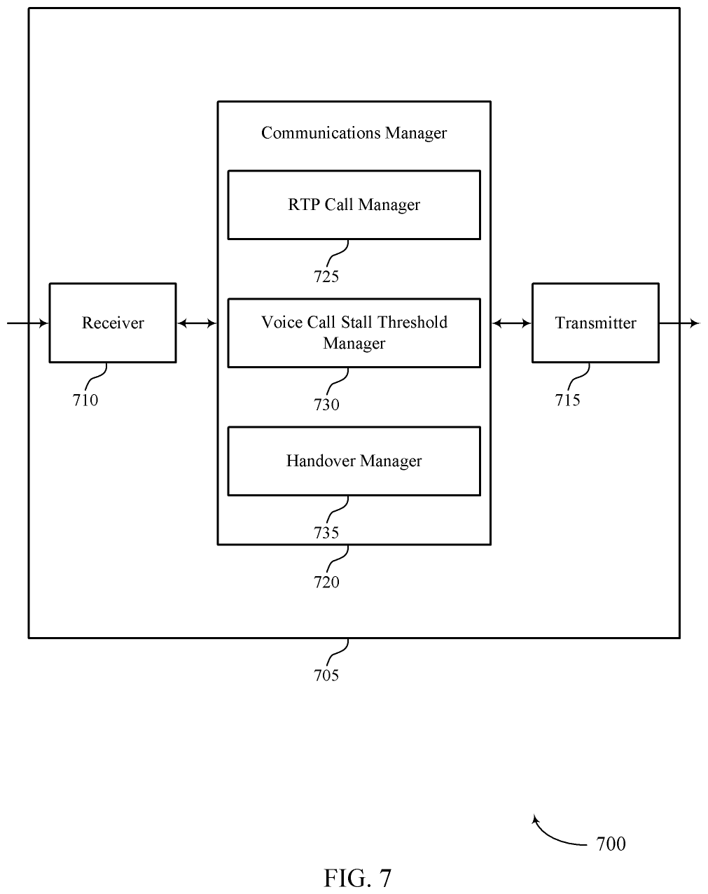

FIG. 7 shows a block diagram 700 of a device 705 that supports techniques for voice call stall detection and mitigation in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for voice call stall detection and mitigation). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for voice call stall detection and mitigation). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of techniques for voice call stall detection and mitigation as described herein. For example, the communications manager 720 may include an RTP call manager 725, a voice call stall threshold manager 730, a handover manager 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. The RTP call manager 725 may be configured as or otherwise support a means for establishing a packet-based voice call with a peer device via a first wireless network entity of a wireless communications system. The voice call stall threshold manager 730 may be configured as or otherwise support a means for identifying a threshold value for a voice stall of the packet-based voice call, the threshold value based on a quantity of voice call packets expected to be received during an active call state of the packet-based voice call during an evaluation period. The handover manager 735 may be configured as or otherwise support a means for initiating a handover of the UE from the first wireless network entity to a different wireless network entity responsive to the quantity of voice call packets received from the peer device during the evaluation period being below the threshold value for the voice stall of the packet-based voice call.

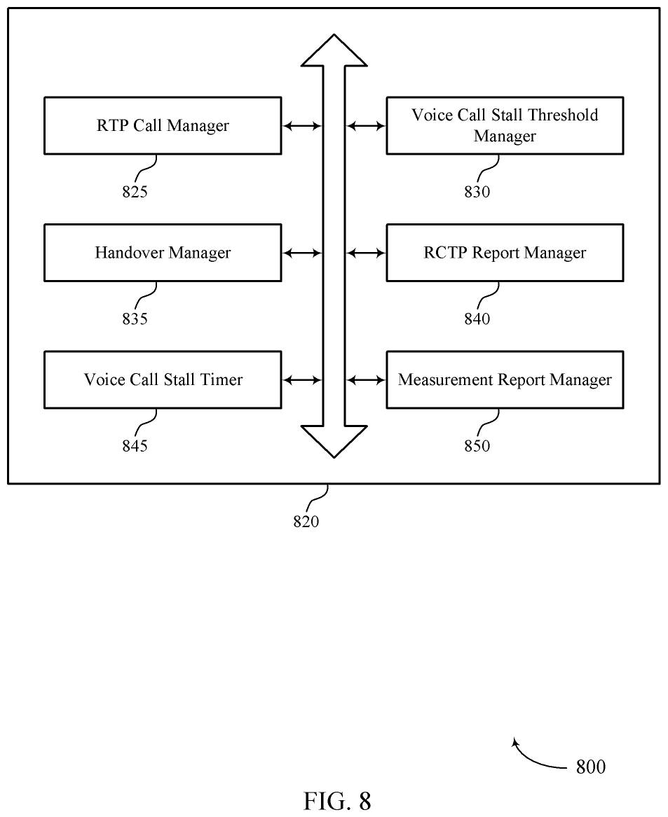

FIG. 8 shows a block diagram 800 of a communications manager 820 that supports techniques for voice call stall detection and mitigation in accordance with one or more aspects of the present disclosure. The communications manager 820 may be an example of aspects of a communications manager 620, a communications manager 720, or both, as described herein. The communications manager 820, or various components thereof, may be an example of means for performing various aspects of techniques for voice call stall detection and mitigation as described herein. For example, the communications manager 820 may include an RTP call manager 825, a voice call stall threshold manager 830, a handover manager 835, an RCTP report manager 840, a voice call stall timer 845, a measurement report manager 850, or any combination thereof. Each of these components may communicate, directly or indirectly, with one another (e.g., via one or more buses).

The communications manager 820 may support wireless communication at a UE in accordance with examples as disclosed herein. The RTP call manager 825 may be configured as or otherwise support a means for establishing a packet-based voice call with a peer device via a first wireless network entity of a wireless communications system. The voice call stall threshold manager 830 may be configured as or otherwise support a means for identifying a threshold value for a voice stall of the packet-based voice call, the threshold value based on a quantity of voice call packets expected to be received during an active call state of the packet-based voice call during an evaluation period. The handover manager 835 may be configured as or otherwise support a means for initiating a handover of the UE from the first wireless network entity to a different wireless network entity responsive to the quantity of voice call packets received from the peer device during the evaluation period being below the threshold value for the voice stall of the packet-based voice call.

In some examples, the RCTP report manager 840 may be configured as or otherwise support a means for receiving, from the peer device, an indication of a quantity of packets transmitted from the peer device for the packet-based voice call, and where the initiating the handover of the UE is based on a ratio of the quantity of voice call packets received from the peer device and the quantity of packets transmitted from the peer device during the evaluation period. In some examples, the indication of the quantity of packets transmitted from the peer device is received in a RTCP sender report from the peer device.

In some examples, the voice call stall timer 845 may be configured as or otherwise support a means for determining that an elapsed time since receipt of a report associated with the packet-based voice call exceeds a time threshold, and where the initiating the handover of the UE is based on the quantity of voice call packets received from the peer device and an estimated quantity of voice call packets associated with an assumed mixed voice pattern for the evaluation period. In some examples, the report associated with the packet-based voice call is a RTCP report. In some examples, the threshold value is based on a SID interval of the packet-based voice call, where a higher SID interval has a lower threshold value, and a lower SID interval has a higher threshold value.

In some examples, the voice call stall threshold manager 830 may be configured as or otherwise support a means for estimating, for the evaluation period, a ratio of an expected quantity of packets transmitted from the peer device during the evaluation period and a maximum quantity of packets that can be transmitted during the evaluation period, and where the threshold value is determined based on the estimated ratio. In some examples, a value of the ratio that is less than a silence threshold indicates that the peer device is silent, and that the UE is to refrain from triggering the handover for the evaluation period. In some examples, the quantity of voice call packets received from the peer device during the evaluation period is based on voice call packets that have RTP timestamps that are within the evaluation period.

In some examples, the identifying the threshold value for the voice stall and, to support initiating the handover of the UE are performed as part of a voice call stall evaluation, and where the method, the RCTP report manager 840 may be configured as or otherwise support a means for receiving at least one RTCP sender report that indicates a quantity of RTP voice packets transmitted during the evaluation period. In some examples, the identifying the threshold value for the voice stall and, to support initiating the handover of the UE are performed as part of a voice call stall evaluation, and where the method, the voice call stall threshold manager 830 may be configured as or otherwise support a means for initiating the voice call stall evaluation responsive to the at least one RTCP sender report, where the threshold value is based on the quantity of RTP voice packets indicated in the sender report and a quantity of SID frames within the evaluation period.

In some examples, the identifying the threshold value for the voice stall and, to support initiating the handover of the UE are performed as part of a voice call stall evaluation, and where the method, the voice call stall timer 845 may be configured as or otherwise support a means for determining that a time period since a prior evaluation period has elapsed, and that a RTCP sender report has not been received within the time period. In some examples, the identifying the threshold value for the voice stall and, to support initiating the handover of the UE are performed as part of a voice call stall evaluation, and where the method, the voice call stall threshold manager 830 may be configured as or otherwise support a means for initiating the voice call stall evaluation responsive to the determining, where the threshold value is based on an assumed mixed voice pattern for the packet-based voice call. In some examples, the threshold value for identifying the voice stall of the packet-based voice call is an adaptive threshold that is based on an amount of voice activity present during the evaluation period.

In some examples, the handover manager 835 may be configured as or otherwise support a means for receiving a handover message that indicates handover of the UE from the first wireless network entity to a second wireless network entity, where the second wireless network entity uses a same RAT as the first wireless network entity or a different RAT than the first wireless network entity.

In some examples, to support initiating the handover of the UE, the measurement report manager 850 may be configured as or otherwise support a means for modifying a criteria for transmission of a measurement report to the first wireless network entity that triggers handover of the UE, where the measurement report is an inter-RAT measurement report or an intra-RAT measurement report based on measured channel conditions associated with wireless network entities of two or more RATs. In some examples, the handover manager 835 may be configured as or otherwise support a means for transmitting the measurement report to the first wireless entity.

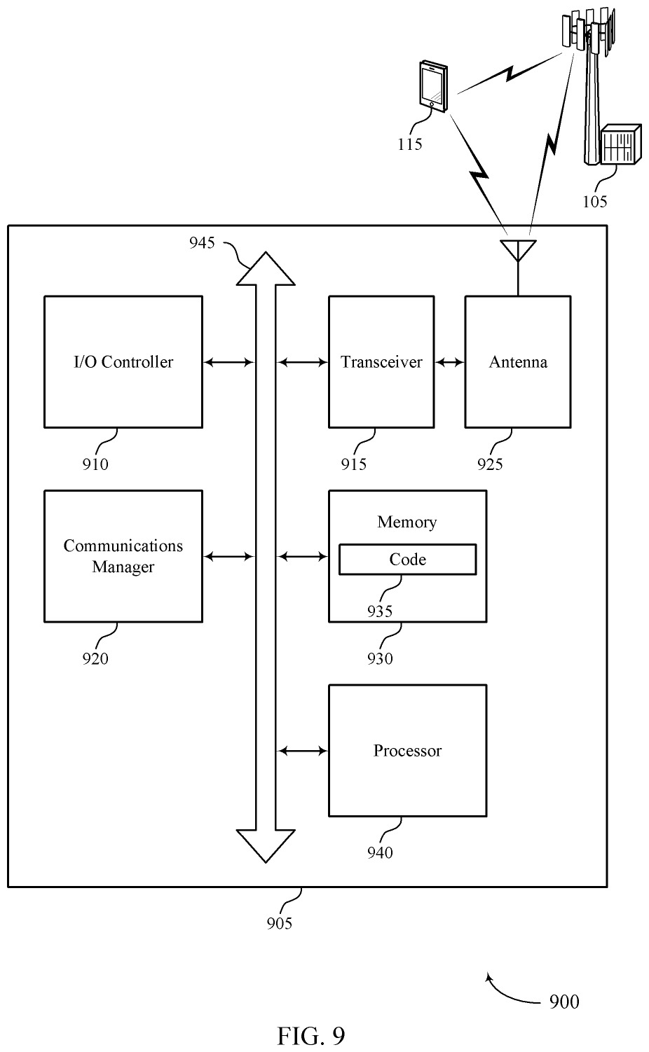

FIG. 9 shows a diagram of a system 900 including a device 905 that supports techniques for voice call stall detection and mitigation in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting techniques for voice call stall detection and mitigation). For example, the device 905 or a component of the device 905 may include a processor 940 and memory 930 coupled with or to the processor 940, the processor 940 and memory 930 configured to perform various functions described herein.

The communications manager 920 may support wireless communication at a UE in accordance with examples as disclosed herein. For example, the communications manager 920 may be configured as or otherwise support a means for establishing a packet-based voice call with a peer device via a first wireless network entity of a wireless communications system. The communications manager 920 may be configured as or otherwise support a means for identifying a threshold value for a voice stall of the packet-based voice call, the threshold value based on a quantity of voice call packets expected to be received during an active call state of the packet-based voice call during an evaluation period. The communications manager 920 may be configured as or otherwise support a means for initiating a handover of the UE from the first wireless network entity to a different wireless network entity responsive to the quantity of voice call packets received from the peer device during the evaluation period being below the threshold value for the voice stall of the packet-based voice call.

By including or configuring the communications manager 920 in accordance with examples as described herein, the device 905 may support techniques for voice call stall evaluation based on a threshold value for a received number of voice packets during an evaluation period, which may mitigate gaps in voice calls to provide an enhanced user experience, enhanced reliability for packet-based voice calls, and/or provide enhanced network efficiency through fewer call failures or call terminations.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of techniques for voice call stall detection and mitigation as described herein, or the processor 940 and the memory 930 may be otherwise configured to perform or support such operations.

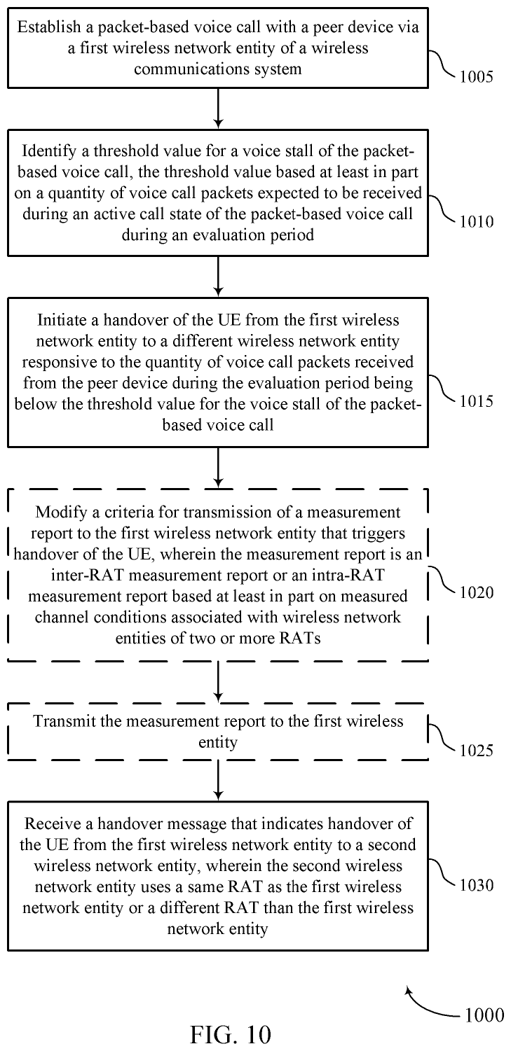

FIG. 10 shows a flowchart illustrating a method 1000 that supports techniques for voice call stall detection and mitigation in accordance with one or more aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include establishing a packet-based voice call with a peer device via a first wireless network entity of a wireless communications system. The operations of 1005 may be performed in accordance with examples as disclosed herein. In some examples, aspects of the operations of 1005 may be performed by an RTP call manager 825 as described with reference to FIG. 8.

At 1010, the method may include identifying a threshold value for a voice stall of the packet-based voice call, the threshold value based on a quantity of voice call packets expected to be received during an active call state of the packet-based voice call during an evaluation period. The operations of 1010 may be performed in accordance with examples as disclosed herein. In some examples, aspects of the operations of 1010 may be performed by a voice call stall threshold manager 830 as described with reference to FIG. 8.

At 1015, the method may include initiating a handover of the UE from the first wireless network entity to a different wireless network entity responsive to the quantity of voice call packets received from the peer device during the evaluation period being below the threshold value for the voice stall of the packet-based voice call. The operations of 1015 may be performed in accordance with examples as disclosed herein. In some examples, aspects of the operations of 1015 may be performed by a handover manager 835 as described with reference to FIG. 8.

In some cases, initiating the handover may include transmitting a measurement report that triggers the handover and in one example, at 1020, the method may include modifying a criteria for transmission of a measurement report to the first wireless network entity that triggers handover of the UE, where the measurement report is an inter-RAT measurement report or an intra-RAT measurement report based on measured channel conditions associated with wireless network entities of two or more RATs. The operations of 1020 may be performed in accordance with examples as disclosed herein. In some examples, aspects of the operations of 1020 may be performed by a measurement report manager 850 as described with reference to FIG. 8.

At 1025, in cases where handover is initiated by such a measurement report transmission, the method may include transmitting the measurement report to the first wireless entity. The operations of 1025 may be performed in accordance with examples as disclosed herein. In some examples, aspects of the operations of 1025 may be performed by a handover manager 835 as described with reference to FIG. 8.

At 1030, the method may include receiving a handover message that indicates handover of the UE from the first wireless network entity to a second wireless network entity, where the second wireless network entity uses a same RAT as the first wireless network entity or a different RAT than the first wireless network entity. The operations of 1030 may be performed in accordance with examples as disclosed herein. In some examples, aspects of the operations of 1030 may be performed by a handover manager 835 as described with reference to FIG. 8.

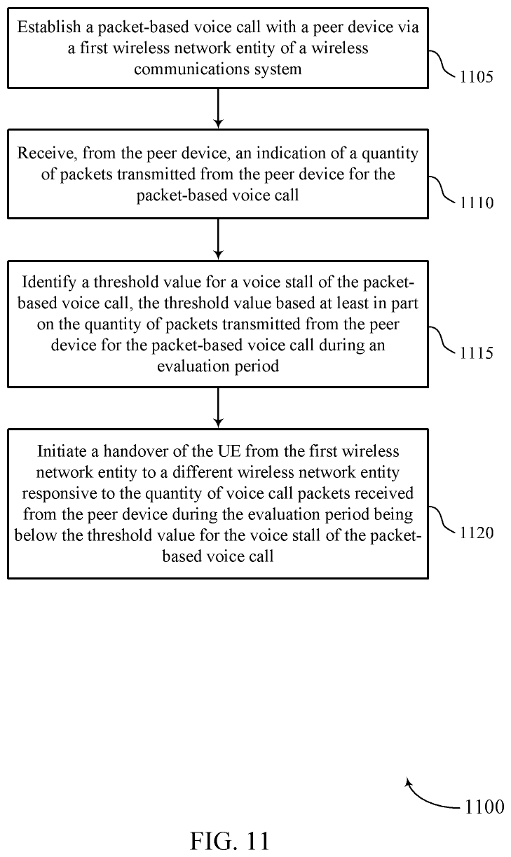

FIG. 11 shows a flowchart illustrating a method 1100 that supports techniques for voice call stall detection and mitigation in accordance with one or more aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include establishing a packet-based voice call with a peer device via a first wireless network entity of a wireless communications system. The operations of 1105 may be performed in accordance with examples as disclosed herein. In some examples, aspects of the operations of 1105 may be performed by an RTP call manager 825 as described with reference to FIG. 8.

At 1110, the method may include receiving, from the peer device, an indication of a quantity of packets transmitted from the peer device for the packet-based voice call. The operations of 1110 may be performed in accordance with examples as disclosed herein. In some examples, aspects of the operations of 1110 may be performed by an RCTP report manager 840 as described with reference to FIG. 8.

At 1115, the method may include identifying a threshold value for a voice stall of the packet-based voice call, the threshold value based on the quantity of packets transmitted from the peer device for the packet-based voice call during an evaluation period. The operations of 1115 may be performed in accordance with examples as disclosed herein. In some examples, aspects of the operations of 1115 may be performed by a voice call stall threshold manager 830 as described with reference to FIG. 8.

At 1120, the method may include initiating a handover of the UE from the first wireless network entity to a different wireless network entity responsive to the quantity of voice call packets received from the peer device during the evaluation period being below the threshold value for the voice stall of the packet-based voice call. The operations of 1120 may be performed in accordance with examples as disclosed herein. In some examples, aspects of the operations of 1120 may be performed by a handover manager 835 as described with reference to FIG. 8. In some cases, the initiating the handover of the UE is based on a ratio of the quantity of voice call packets received from the peer device and the quantity of packets transmitted from the peer device during the evaluation period

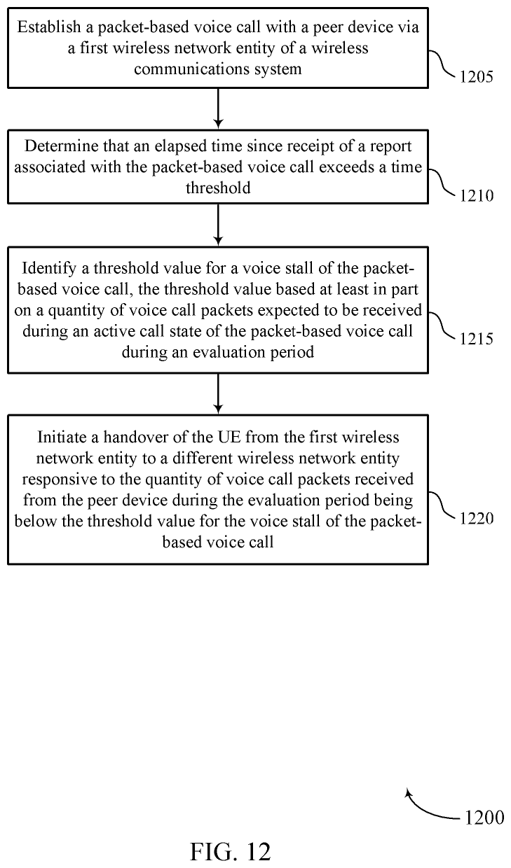

FIG. 12 shows a flowchart illustrating a method 1200 that supports techniques for voice call stall detection and mitigation in accordance with one or more aspects of the present disclosure. The operations of the method 1200 may be implemented by a UE or its components as described herein. For example, the operations of the method 1200 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1205, the method may include establishing a packet-based voice call with a peer device via a first wireless network entity of a wireless communications system. The operations of 1205 may be performed in accordance with examples as disclosed herein. In some examples, aspects of the operations of 1205 may be performed by an RTP call manager 825 as described with reference to FIG. 8.

At 1210, the method may include determining that an elapsed time since receipt of a report associated with the packet-based voice call exceeds a time threshold. The operations of 1210 may be performed in accordance with examples as disclosed herein. In some examples, aspects of the operations of 1210 may be performed by a voice call stall timer 845 as described with reference to FIG. 8.

At 1215, the method may include identifying a threshold value for a voice stall of the packet-based voice call, the threshold value based on a quantity of voice call packets expected to be received during an active call state of the packet-based voice call during an evaluation period. The operations of 1215 may be performed in accordance with examples as disclosed herein. In some examples, aspects of the operations of 1215 may be performed by a voice call stall threshold manager 830 as described with reference to FIG. 8.

At 1220, the method may include initiating a handover of the UE from the first wireless network entity to a different wireless network entity responsive to the quantity of voice call packets received from the peer device during the evaluation period being below the threshold value for the voice stall of the packet-based voice call. The operations of 1220 may be performed in accordance with examples as disclosed herein. In some examples, aspects of the operations of 1220 may be performed by a handover manager 835 as described with reference to FIG. 8. In some cases, the initiating the handover of the UE is based on the quantity of voice call packets received from the peer device and an estimated quantity of voice call packets associated with an assumed mixed voice pattern for the evaluation period.

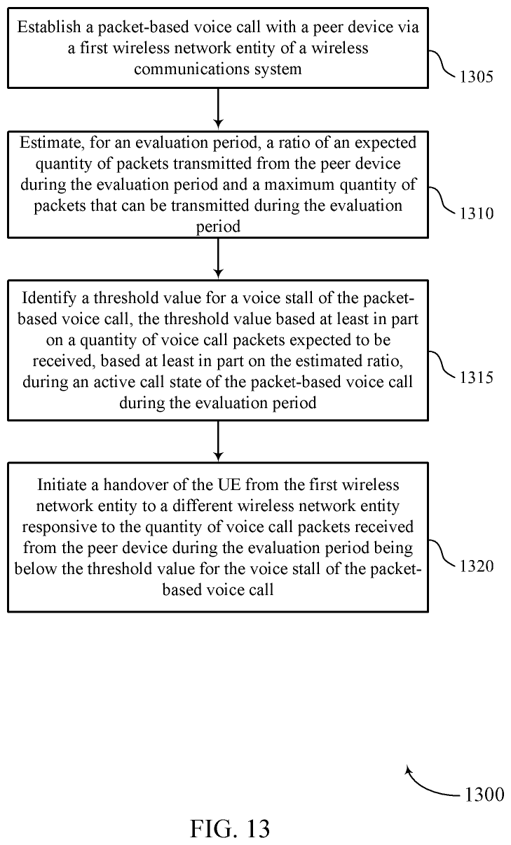

FIG. 13 shows a flowchart illustrating a method 1300 that supports techniques for voice call stall detection and mitigation in accordance with one or more aspects of the present disclosure. The operations of the method 1300 may be implemented by a UE or its components as described herein. For example, the operations of the method 1300 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1305, the method may include establishing a packet-based voice call with a peer device via a first wireless network entity of a wireless communications system. The operations of 1305 may be performed in accordance with examples as disclosed herein. In some examples, aspects of the operations of 1305 may be performed by an RTP call manager 825 as described with reference to FIG. 8.

At 1310, the method may include estimating, for an evaluation period, a ratio of an expected quantity of packets transmitted from the peer device during the evaluation period and a maximum quantity of packets that can be transmitted during the evaluation period. The operations of 1310 may be performed in accordance with examples as disclosed herein. In some examples, aspects of the operations of 1310 may be performed by a voice call stall threshold manager 830 as described with reference to FIG. 8.

At 1315, the method may include identifying a threshold value for a voice stall of the packet-based voice call, the threshold value based on a quantity of voice call packets expected to be received, based on the estimated ratio, during an active call state of the packet-based voice call during the evaluation period. The operations of 1315 may be performed in accordance with examples as disclosed herein. In some examples, aspects of the operations of 1315 may be performed by a voice call stall threshold manager 830 as described with reference to FIG. 8.

At 1320, the method may include initiating a handover of the UE from the first wireless network entity to a different wireless network entity responsive to the quantity of voice call packets received from the peer device during the evaluation period being below the threshold value for the voice stall of the packet-based voice call. The operations of 1320 may be performed in accordance with examples as disclosed herein. In some examples, aspects of the operations of 1320 may be performed by a handover manager 835 as described with reference to FIG. 8.

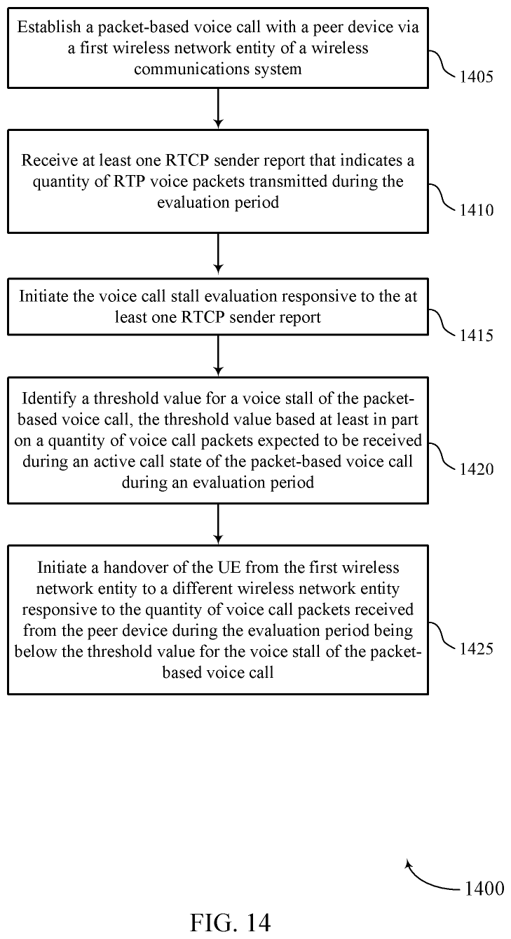

FIG. 14 shows a flowchart illustrating a method 1400 that supports techniques for voice call stall detection and mitigation in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include establishing a packet-based voice call with a peer device via a first wireless network entity of a wireless communications system. The operations of 1405 may be performed in accordance with examples as disclosed herein. In some examples, aspects of the operations of 1405 may be performed by an RTP call manager 825 as described with reference to FIG. 8.

At 1410, the method may include receiving at least one RTCP sender report that indicates a quantity of RTP voice packets transmitted during the evaluation period. The operations of 1410 may be performed in accordance with examples as disclosed herein. In some examples, aspects of the operations of 1410 may be performed by an RCTP report manager 840 as described with reference to FIG. 8.

At 1415, the method may include initiating the voice call stall evaluation responsive to the at least one RTCP sender report. The operations of 1415 may be performed in accordance with examples as disclosed herein. In some examples, aspects of the operations of 1415 may be performed by a voice call stall threshold manager 830 as described with reference to FIG. 8.

At 1420, the method may include identifying a threshold value for a voice stall of the packet-based voice call, the threshold value based on a quantity of voice call packets expected to be received during an active call state of the packet-based voice call during an evaluation period. The operations of 1420 may be performed in accordance with examples as disclosed herein. In some examples, aspects of the operations of 1420 may be performed by a voice call stall threshold manager 830 as described with reference to FIG. 8. In some cases, the threshold value is based on the quantity of RTP voice packets indicated in the sender report and a quantity of SID frames within the evaluation period.

At 1425, the method may include initiating a handover of the UE from the first wireless network entity to a different wireless network entity responsive to the quantity of voice call packets received from the peer device during the evaluation period being below the threshold value for the voice stall of the packet-based voice call. The operations of 1425 may be performed in accordance with examples as disclosed herein. In some examples, aspects of the operations of 1425 may be performed by a handover manager 835 as described with reference to FIG. 8.

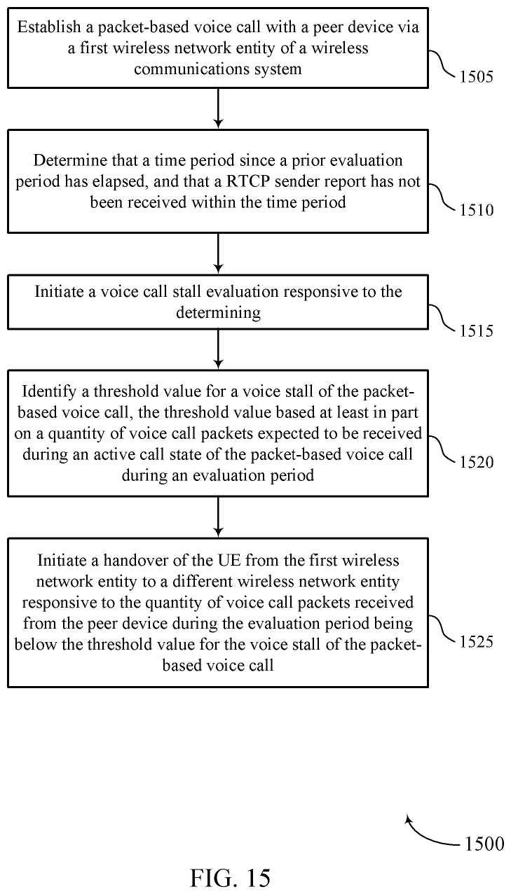

FIG. 15 shows a flowchart illustrating a method 1500 that supports techniques for voice call stall detection and mitigation in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include establishing a packet-based voice call with a peer device via a first wireless network entity of a wireless communications system. The operations of 1505 may be performed in accordance with examples as disclosed herein. In some examples, aspects of the operations of 1505 may be performed by an RTP call manager 825 as described with reference to FIG. 8.

At 1510, the method may include determining that a time period since a prior evaluation period has elapsed, and that a RTCP sender report has not been received within the time period. The operations of 1510 may be performed in accordance with examples as disclosed herein. In some examples, aspects of the operations of 1510 may be performed by a voice call stall timer 845 as described with reference to FIG. 8.

At 1515, the method may include initiating a voice call stall evaluation responsive to the determining. The operations of 1515 may be performed in accordance with examples as disclosed herein. In some examples, aspects of the operations of 1515 may be performed by a voice call stall threshold manager 830 as described with reference to FIG. 8.

At 1520, the method may include identifying a threshold value for a voice stall of the packet-based voice call, the threshold value based on a quantity of voice call packets expected to be received during an active call state of the packet-based voice call during an evaluation period. The operations of 1520 may be performed in accordance with examples as disclosed herein. In some examples, aspects of the operations of 1520 may be performed by a voice call stall threshold manager 830 as described with reference to FIG. 8. In some cases, the threshold value is based on an assumed mixed voice pattern for the packet-based voice call.

At 1525, the method may include initiating a handover of the UE from the first wireless network entity to a different wireless network entity responsive to the quantity of voice call packets received from the peer device during the evaluation period being below the threshold value for the voice stall of the packet-based voice call. The operations of 1525 may be performed in accordance with examples as disclosed herein. In some examples, aspects of the operations of 1525 may be performed by a handover manager 835 as described with reference to FIG. 8.

The following provides an overview of aspects of the present disclosure:

Aspect 1: A method for wireless communication at a UE, comprising: establishing a packet-based voice call with a peer device via a first wireless network entity of a wireless communications system; identifying a threshold value for a voice stall of the packet-based voice call, the threshold value based at least in part on a quantity of voice call packets expected to be received during an active call state of the packet-based voice call during an evaluation period; and initiating a handover of the UE from the first wireless network entity to a different wireless network entity responsive to the quantity of voice call packets received from the peer device during the evaluation period being below the threshold value for the voice stall of the packet-based voice call.

Aspect 2: The method of aspect 1, further comprising: receiving, from the peer device, an indication of a quantity of packets transmitted from the peer device for the packet-based voice call, and wherein the initiating the handover of the UE is based at least in part on a ratio of the quantity of voice call packets received from the peer device and the quantity of packets transmitted from the peer device during the evaluation period.

Aspect 3: The method of aspect 2, wherein the indication of the quantity of packets transmitted from the peer device is received in a RTCP sender report from the peer device.

Aspect 4: The method of any of aspects 1 through 3, further comprising: determining that an elapsed time since receipt of a report associated with the packet-based voice call exceeds a time threshold, and wherein the initiating the handover of the UE is based at least in part on the quantity of voice call packets received from the peer device and an estimated quantity of voice call packets associated with an assumed mixed voice pattern for the evaluation period.

Aspect 5: The method of aspect 4, wherein the report associated with the packet-based voice call is a RTCP report.

Aspect 6: The method of any of aspects 1 through 5, wherein the threshold value is based at least in part on a SID interval of the packet-based voice call, wherein a higher SID interval has a lower threshold value, and a lower SID interval has a higher threshold value.

Aspect 7: The method of any of aspects 1 through 6, further comprising: estimating, for the evaluation period, a ratio of an expected quantity of packets transmitted from the peer device during the evaluation period and a maximum quantity of packets that can be transmitted during the evaluation period, and wherein the threshold value is determined based at least in part on the estimated ratio.

Aspect 8: The method of aspect 7, wherein a value of the ratio that is less than a silence threshold indicates that the peer device is silent, and that the UE is to refrain from triggering the handover for the evaluation period.

Aspect 9: The method of any of aspects 1 through 8, wherein the quantity of voice call packets received from the peer device during the evaluation period is based at least in part on voice call packets that have RTP timestamps that are within the evaluation period.

Aspect 10: The method of any of aspects 1 through 9, wherein the identifying the threshold value for the voice stall and the initiating the handover of the UE are performed as part of a voice call stall evaluation, and wherein the method further comprises: receiving at least one RTCP sender report that indicates a quantity of RTP voice packets transmitted during the evaluation period; and initiating the voice call stall evaluation responsive to the at least one RTCP sender report, wherein the threshold value is based at least in part on the quantity of RTP voice packets indicated in the sender report and a quantity of SID frames within the evaluation period.

Aspect 11: The method of any of aspects 1 through 10, wherein the identifying the threshold value for the voice stall and the initiating the handover of the UE are performed as part of a voice call stall evaluation, and wherein the method further comprises: determining that a time period since a prior evaluation period has elapsed, and that a RTCP sender report has not been received within the time period; and initiating the voice call stall evaluation responsive to the determining, wherein the threshold value is based at least in part on an assumed mixed voice pattern for the packet-based voice call.

Aspect 12: The method of any of aspects 1 through 11, wherein the threshold value for identifying the voice stall of the packet-based voice call is an adaptive threshold that is based at least in part on an amount of voice activity present during the evaluation period.

Aspect 13: The method of any of aspects 1 through 12, further comprising: receiving a handover message that indicates handover of the UE from the first wireless network entity to a second wireless network entity, wherein the second wireless network entity uses a same RAT as the first wireless network entity or a different RAT than the first wireless network entity.

Aspect 14: The method of aspect 13, wherein the initiating the handover of the UE comprises: modifying a criteria for transmission of a measurement report to the first wireless network entity that triggers handover of the UE, wherein the measurement report is an inter-RAT measurement report or an intra-RAT measurement report based at least in part on measured channel conditions associated with wireless network entities of two or more RATs.

Aspect 15: An apparatus for wireless communication at a UE, comprising a processor; memory coupled with the processor; and instructions stored in the memory and executable by the processor to cause the apparatus to perform a method of any of aspects 1 through 14.

Aspect 16: An apparatus for wireless communication at a UE, comprising at least one means for performing a method of any of aspects 1 through 14.

Aspect 17: A non-transitory computer-readable medium storing code for wireless communication at a UE, the code comprising instructions executable by a processor to perform a method of any of aspects 1 through 14.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
establishing a packet-based voice call with a peer device via a first wireless network entity of a wireless communications system;
identifying a threshold value for a voice stall of the packet-based voice call, the threshold value based at least in part on a quantity of voice call packets expected to be received during an active call state of the packet-based voice call during an evaluation period; and
initiating a handover of the UE from the first wireless network entity to a different wireless network entity responsive to the quantity of voice call packets received from the peer device during the evaluation period being below the threshold value for the voice stall of the packet-based voice call.

2. The method of claim 1, further comprising:
receiving, from the peer device, an indication of a quantity of packets transmitted from the peer device for the packet-based voice call, and wherein the initiating the handover of the UE is based at least in part on a ratio of the quantity of voice call packets received from the peer device and the quantity of packets transmitted from the peer device during the evaluation period.

3. The method of claim 2, wherein the indication of the quantity of packets transmitted from the peer device is received in a real-time transport control protocol (RTCP) sender report from the peer device.

4. The method of claim 1, further comprising:
determining that an elapsed time since receipt of a report associated with the packet-based voice call exceeds a time threshold, and wherein the initiating the handover of the UE is based at least in part on the quantity of voice call packets received from the peer device and an estimated quantity of voice call packets associated with an assumed mixed voice pattern for the evaluation period.

5. The method of claim 4, wherein the report associated with the packet-based voice call is a real-time transport control protocol (RTCP) report.

6. The method of claim 1, wherein the threshold value is based at least in part on a silence indicator (SID) interval of the packet-based voice call, wherein a higher SID interval has a lower threshold value, and a lower SID interval has a higher threshold value. 7 The method of claim 1, further comprising:
estimating, for the evaluation period, a ratio of an expected quantity of packets transmitted from the peer device during the evaluation period and a maximum quantity of packets that can be transmitted during the evaluation period, and wherein the threshold value is determined based at least in part on the estimated ratio.

8. The method of claim 7, wherein a value of the ratio that is less than a silence threshold indicates that the peer device is silent, and that the UE is to refrain from triggering the handover for the evaluation period.

9. The method of claim 1, wherein the quantity of voice call packets received from the peer device during the evaluation period is based at least in part on voice call packets that have real-time transport protocol (RTP) timestamps that are within the evaluation period.

10. The method of claim 1, wherein the identifying the threshold value for the voice stall and the initiating the handover of the UE are performed as part of a voice call stall evaluation, and wherein the method further comprises:
receiving at least one real-time transport control protocol (RTCP) sender report that indicates a quantity of real-time transport protocol (RTP) voice packets transmitted during the evaluation period; and
initiating the voice call stall evaluation responsive to the at least one RTCP sender report, wherein the threshold value is based at least in part on the quantity of RTP voice packets indicated in the sender report and a quantity of silence indicator (SID) frames within the evaluation period.

11. The method of claim 1, wherein the identifying the threshold value for the voice stall and the initiating the handover of the UE are performed as part of a voice call stall evaluation, and wherein the method further comprises:
determining that a time period since a prior evaluation period has elapsed, and that a real-time transport control protocol (RTCP) sender report has not been received within the time period; and
initiating the voice call stall evaluation responsive to the determining, wherein the threshold value is based at least in part on an assumed mixed voice pattern for the packet-based voice call.

12. The method of claim 1, wherein the threshold value for identifying the voice stall of the packet-based voice call is an adaptive threshold that is based at least in part on an amount of voice activity present during the evaluation period.

13. The method of claim 1, further comprising:
receiving a handover message that indicates handover of the UE from the first wireless network entity to a second wireless network entity, wherein the second wireless network entity uses a same radio access technology (RAT) as the first wireless network entity or a different RAT than the first wireless network entity.

14. The method of claim 13, wherein the initiating the handover of the UE comprises:
modifying a criteria for transmission of a measurement report to the first wireless network entity that triggers handover of the UE, wherein the measurement report is an inter-RAT measurement report or an intra-RAT measurement report based at least in part on measured channel conditions associated with wireless network entities of two or more RATs.

15. An apparatus for wireless communication at a user equipment (UE), comprising:
a processor;
memory coupled with the processor; and
instructions stored in the memory and executable by the processor to cause the apparatus to:
establish a packet-based voice call with a peer device via a first wireless network entity of a wireless communications system;
identify a threshold value for a voice stall of the packet-based voice call, the threshold value based at least in part on a quantity of voice call packets expected to be received during an active call state of the packet-based voice call during an evaluation period; and
initiate a handover of the UE from the first wireless network entity to a different wireless network entity responsive to the quantity of voice call packets received from the peer device during the evaluation period being below the threshold value for the voice stall of the packet-based voice call.

16. The apparatus of claim 15, wherein the instructions are further executable by the processor to cause the apparatus to:
receive, from the peer device, an indication of a quantity of packets transmitted from the peer device for the packet-based voice call, and wherein the initiation of the handover of the UE is based at least in part on a ratio of the quantity of voice call packets received from the peer device and the quantity of packets transmitted from the peer device during the evaluation period.

17. The apparatus of claim 16, wherein the indication of the quantity of packets transmitted from the peer device is received in a real-time transport control protocol (RTCP) sender report from the peer device.

18. The apparatus of claim 15, wherein the instructions are further executable by the processor to cause the apparatus to:
determine that an elapsed time since receipt of a report associated with the packet-based voice call exceeds a time threshold, and wherein the initiation of the handover of the UE is based at least in part on the quantity of voice call packets received from the peer device and an estimated quantity of voice call packets associated with an assumed mixed voice pattern for the evaluation period.

19. The apparatus of claim 18, wherein the report associated with the packet-based voice call is a real-time transport control protocol (RTCP) report.

20. The apparatus of claim 15, wherein the threshold value is based at least in part on a silence indicator (SID) interval of the packet-based voice call, wherein a higher SID interval has a lower threshold value, and a lower SID interval has a higher threshold value.

21. The apparatus of claim 15, wherein the instructions are further executable by the processor to cause the apparatus to:
estimate, for the evaluation period, a ratio of an expected quantity of packets transmitted from the peer device during the evaluation period and a maximum quantity of packets that can be transmitted during the evaluation period, and wherein the threshold value is determined based at least in part on the estimated ratio.

22. The apparatus of claim 15, wherein the instructions to identify the threshold value for the voice stall and the instructions to initiate the handover of the UE are executed as part of a voice call stall evaluation, and wherein the instructions are further executable by the processor to cause the apparatus to:
receive at least one real-time transport control protocol (RTCP) sender report that indicates a quantity of real-time transport protocol (RTP) voice packets transmitted during the evaluation period; and
initiate the voice call stall evaluation responsive to the at least one RTCP sender report, wherein the threshold value is based at least in part on the quantity of RTP voice packets indicated in the sender report and a quantity of silence indicator (SID) frames within the evaluation period.

23. The apparatus of claim 15, wherein the instructions to identify the threshold value for the voice stall and the instructions to initiate the handover of the UE are executed as part of a voice call stall evaluation, and wherein the instructions are further executable by the processor to cause the apparatus to:
determine that a time period since a prior evaluation period has elapsed, and that a real-time transport control protocol (RTCP) sender report has not been received within the time period; and
initiate the voice call stall evaluation responsive to the determination, wherein the threshold value is based at least in part on an assumed mixed voice pattern for the packet-based voice call.

24. The apparatus of claim 15, wherein the instructions are further executable by the processor to cause the apparatus to:
receive a handover message that indicates handover of the UE from the first wireless network entity to a second wireless network entity, wherein the second wireless network entity uses a same radio access technology (RAT) as the first wireless network entity or a different RAT than the first wireless network entity.

25. An apparatus for wireless communication at a user equipment (UE), comprising:
means for establishing a packet-based voice call with a peer device via a first wireless network entity of a wireless communications system;
means for identifying a threshold value for a voice stall of the packet-based voice call, the threshold value based at least in part on a quantity of voice call packets expected to be received during an active call state of the packet-based voice call during an evaluation period; and
means for initiating a handover of the UE from the first wireless network entity to a different wireless network entity responsive to the quantity of voice call packets received from the peer device during the evaluation period being below the threshold value for the voice stall of the packet-based voice call.

26. The apparatus of claim 25, further comprising:
means for receiving, from the peer device, an indication of a quantity of packets transmitted from the peer device for the packet-based voice call, and wherein initiation of the handover of the UE is based at least in part on a ratio of the quantity of voice call packets received from the peer device and the quantity of packets transmitted from the peer device during the evaluation period.

27. The apparatus of claim 25, wherein identification of the threshold value and initiation of the handover of the UE are performed as part of a voice call stall evaluation, and wherein the apparatus further comprises:
means for receiving at least one real-time transport control protocol (RTCP) sender report that indicates a quantity of real-time transport protocol (RTP) voice packets transmitted during the evaluation period; and
means for initiating the voice call stall evaluation responsive to the at least one RTCP sender report, wherein the threshold value is based at least in part on the quantity of RTP voice packets indicated in the sender report and a quantity of silence indicator (SID) frames within the evaluation period.

28. A non-transitory computer-readable medium storing code for wireless communication at a user equipment (UE), the code comprising instructions executable by a processor to:
establish a packet-based voice call with a peer device via a first wireless network entity of a wireless communications system;
identify a threshold value for a voice stall of the packet-based voice call, the threshold value based at least in part on a quantity of voice call packets expected to be received during an active call state of the packet-based voice call during an evaluation period; and
initiate a handover of the UE from the first wireless network entity to a different wireless network entity responsive to the quantity of voice call packets received from the peer device during the evaluation period being below the threshold value for the voice stall of the packet-based voice call.

29. The non-transitory computer-readable medium of claim 28, wherein the instructions are further executable by the processor to:
receive, from the peer device, an indication of a quantity of packets transmitted from the peer device for the packet-based voice call, and wherein the initiating the handover of the UE is based at least in part on a ratio of the quantity of voice call packets received from the peer device and the quantity of packets transmitted from the peer device during the evaluation period.

30. The non-transitory computer-readable medium of claim 28, wherein the instructions are further executable by the processor to:
determine that an elapsed time since receipt of a report associated with the packet-based voice call exceeds a time threshold, and wherein the initiating the handover of the UE is based at least in part on the quantity of voice call packets received from the peer device and an estimated quantity of voice call packets associated with an assumed mixed voice pattern for the evaluation period.
